(19) United States
(12) Patent Application Publication
(10) Pub. No.: US 2021/0321580 A1
(43) Pub. Date: Oct. 21, 2021

(54) CHEMICALLY TREATED ANIMAL FIBER MATRIX PLANT CULTIVATION COMPOSITION

(71) Applicant: Kathleen Marie Dwire, Lenore, ID (US)

(72) Inventor: Kathleen Marie Dwire, Lenore, ID (US)

(21) Appl. No.: 16/854,573

(22) Filed: Apr. 21, 2020

(51) Int. Cl. A01G 24/20; A01G 31/00; A01G 24/46

(52) U.S. Cl. CPC A01G 24/20; A01G 24/46; A01G 31/00

(57) ABSTRACT

A soil-less plant cultivation substrate, for use in hydroponic or aeroponic plant cultivation, adapts entangled layers of natural wool batting that has been chemically treated with a compound containing thiol to increase its water holding capacity. In the preferred embodiment, the chemical treatment uses thioglycolic acid, such as calcium thioglycolate or ammonium thioglycolate, to increase the wool's solubility and then a neutralizing agent, such as hydrogen peroxide, halts the process. The thiol compound reduces the disulfide bonds of cysteine in the cortex of the wool and the hydrogen peroxide neutralizes the reaction and oxidizes the cysteines back to cystine, although not all disulfide bonds are reformed. The addition of an alkaline modifier is used to moderate or hasten the breaking the disulfide bonds.

### 1. FIELD OF THE INVENTION

The present invention relates to a soil substitute useful in supporting plant growth, most commonly in hydroponic media. More particularly, the present invention relates to entangled natural wool that is chemically treated to increase its water holding capacity when used in hydroponic media for plant cultivation.

### 2. BACKGROUND OF THE INVENTION

Soil-less plant cultivation media and artificial substrates are now commonly used, either alone or with various admixtures, for the germination, rooting and propagation of horticultural crops. For example, at least a third of the lettuce produced in the United States is grown hydroponically. The benefits of hydroponic agriculture include higher yields, water efficiency, continuous production, and versatility. See G. L. Barbosa, et al., Comparison of Land, Water, and Energy Requirements of Lettuce Grown Using Hydroponic vs. Conventional Agricultural Methods, Int. J. Environ. Res. Public Health (June 2015), 6879-6891, 6879 (available at https://www.ncbi.nlm.nih.gov/pmc/articles/PMC4483736/). Many crops can be grown using hydroponics, such as tomatoes, cucumbers, peppers, eggplants, strawberries, etc. Hydroponic production involves the circulation of a nutrient solution through channels. Mineral wool, coir, glass wool, clay spheres, perlite, cellulose fiber, peat moss, plastic particles, rigid synthetic foams and synthetic polymer fiber mats are known to the industry as acceptable plant cultivation substrates. The disadvantages with the use of these substrates generally lie in one or more areas. U.S. Pat. No. 4,803,803 to Moffet, Jr. (“Moffet”) describes a growing medium for plants comprising a blend of mineral wool, phenolic resin and vermiculite intended provide a lightweight growth media with a suitable pH and enhanced water absorption. The composition of Moffet sought to overcome the shortcomings of each of these materials separately.

Waterlogging is a common problem with numerous artificial substrates including coir, peat, and rock wool, as these materials cannot adequately drain appreciable amounts of water. Additionally, these materials inhibit the exchange of gases, thereby creating an anerobic environment that inhibits plant growth and encourages pathogenic effects.

U.S. Pat. No. 2,923,093 to Allen in 1960 describes a seed planting mat comprising three layers of a fibrous base (5), a growing media (6) of fertilizers and mulch (7), in which seeds (8) are evenly distributed, on top of the base (5), and a fibrous top cover layer (9). These layers are bound by needle punching from the top to the base. See Allen, at col. 2, lines 3-40. The resulting mat protects the seed bed against erosion as well as wind and bird depredation, and is intended for simple application to a soil surface, where the materials will gradually disintegrate over time. The mat as defined is thin in relation to the present invention and is not intended to serve as the entire plant cultivation matrix, but simply an environmental barrier.

Several common artificial substrates, due to their inherent pH, are not conducive to healthy plant growth without continued monitoring and adjustment. One such artificial substrate, rock wool, creates an undesirable alkaline environment, and another, peat moss, has an acidic nature. Both impede plant growth if not carefully managed.

Another consideration is the desire to avoid use of non-renewable resources for the propagation of agricultural crops and find, instead, sustainable agricultural materials and methods. One example of non-renewable resource being used for cultivation is peat, which has resulted in the mining of peat bogs at an alarming rate. Another well known example is agriculture's use of non-renewable petrochemicals throughout commercial cultivation, including their use in production of synthetic media, which is discarded after a single crop.

Wood fibers, in either a mechanically reduced or digested form, are known in the art to be an acceptable mulch, as disclosed in U.S. Pat. No. 5,741,832 to Spittle. According to Spittle, natural wood fiber has reasonable moisture holding properties, but the lack of entanglement capacity does not allow it to form or maintain a cohesive matrix capable of plant support without a binding agent, but such binders form a layer that prevents water and oxygen from passing through to the seed bed. See Spittle, at Col. 1, lines 22-40. To overcome this problem, Spittle proposes mixing wood fibers with synthetic fibers to bind the wood fibers together. Id., at col. 2, lines 8-11. The use of non-renewable synthetic materials creates problems for sustainability and ecological damage.

A renewable resource proposed for use in plant cultivation is coir, the outer husk of coconuts. However, coir exhibits detrimental effects on plant growth due to salt leachate as well as its tendency to waterlog, which creates a stagnant environment that inhibits growth. In addition, coir material is grown only in tropical regions and its transport is costly and uses non-renewable resources for transportation.

Synthetic fibers, which can be generally inert, are used in plant cultivation, but these media are largely produced from non-renewable resources and they are often hydrophobic, which inhibits water retention necessary for growth. For example, U.S. Pat. No. 5,363,593 to Hsh, describes an artificial cultivation medium comprising of fibrous glomerates of chiefly polyacrylonitrile fibers, which are chemically treated and mechanically intertwined in an effort to render them inert. See Hsh, at col. 1, lines 39-49. Similarly, U.S. Pat. No. 6,555,219 to Kosinski describes polymer “fiberballs” treated with a silicone slickener. See Kosinski, col. 7, lines 20-26.

Rock or mineral wool has been a mainstay in the horticultural industry for many years, but the glass-like respirable particulate matter associated with these materials has been found to be harmful. See C. F. Robinson, et al., Mortality Patterns of Rock and Slag Mineral Wool Production Workers: An Epidemiological and Environmental Study, Br. J. Ind. Med. 1982, vol. 39, 45-53. In 1992, the U.S. Environmental Protection Agency deemed rock wool a pulmonary hazard, as inhalation of the fibers can cause pulmonary disease comparable to silicosis from inhaled glass fibers from glass wool insulation. These health effects have led many people to seek less harmful materials. In addition to the potential for respiratory ailment associated with glass, mineral wool, or vermiculite substrates, these materials tend to waterlog, which prevents the necessary transfer of gasses and promotes plant disease. Moreover, Rock wool is alkaline and requires a pre-soak to lower the pH as well as continued monitoring and adjustments. To address some of these problems, U.S. Pat. No. 6,183,531 to De Groot et al. (“De Groot”) discloses the incorporation of clay into the mineral wool matrix to moderate the alkaline reaction associated with the use of rock wool. See De Groot, col. 1, line 64 through col. 2, line 3. Finally. Rock wool is not a renewable resource.

Clay spheres, vermiculite, perlite and sand are all nearly inert materials and can be suitable environments, but their lack of cohesive structure can substantially damage root tissue during transplanting or if the material is moved. Mechanical compression and the use of a cured binding agent, as disclosed in U.S. Pat. No. 5,992,093 to De Groot et al., attempts to create a more rigid support structure for plant cultivation.

What is needed is a medium for the cultivation and propagation of plants that is both sustainable in nature, does not create adverse health effects, and creates an environment that encourages healthy plant growth Animal wool could be a suitable material and such a use, especially since the harvesting of natural animal wool produces substantial quantities of waste wool, which would otherwise be disposed. In addition, a cultivation medium should not rely on materials that must be transported over large distances. In this respect, wool is produced in nearly all continents and climates and the market for the low quality or waste wool allows for an additional income stream for wool producers.

### 3. SUMMARY OF THE INVENTION

This invention provides a plant cultivation matrix comprised of chemically treated wool, primarily animal-derived organic fibers with lesser quantities of synthetic or plant derived fibers, mechanically needled into a cohesive mat. The chemical treatment of the wool fibers greatly increases the water holding capacity of the medium. Needle felting entanglement of the fibers produces a relatively vertically-aligned matrix of fibers, which promotes healthy natural root growth, as opposed to horizontally aligned fibers which are produced in the typical compaction or roller pressed methods.

The chemical treatment of the wool uses a thioglycolate or salt of thioglycolic acid to reduce the disulfide bonds of cystine in the cortex of the wool. Not all disulfide bonds are reformed, so the addition of an alkaline substance, such as sodium hydroxide, calcium hydroxide, potassium hydroxide, or ammonium hydroxide, is used to moderate or hasten the reaction of breaking the disulfide bonds in the hair cortex. After treatment with the thiol compound, the wool is compressed to squeeze out the thiol compound, rinsed with water, and then treated with hydrogen peroxide to neutralize the reaction and oxidize the cysteines back to cystine.

The hydrophilic nature of animal wool allows the material to absorb 30% by weight of water without the material becoming waterlogged. This natural moisture holding capacity of the animal wool prevents roots from drying, thereby maintaining a preferential environment for plant survival and growth. As noted above, synthetic fibers typically lack the natural hydrophilic properties of natural wool and thus do not have the ability to maintain the high moisture holding capacity yet still allow for high oxygen saturation and transfer of gasses. In addition, the naturally occurring wool fibers contain greases or lanolin that acts as a natural bacteriostat preventing unwanted parasites and plant disease.

In the present invention, bats of wool are positioned in layers so that mostly horizontal fibers are aligned in different directions and then vertically punched through with barbed needles to force the horizontal fibers through the layers to entangle the layers vertically and create a vertically-oriented fiber matrix in which plant roots can orient and penetrate. This needle punching enhances plant growth by preventing roots from growing horizontally (typical when compaction or roller pressed material is used), where they are more susceptible to disease. The keratin derived microscopic cortical scales present on animal wool fibers reinforces the entanglement effect of needle punch processing to achieve permanently entangled mat. Animal wool possesses crimp, which gives the fiber elasticity and allows it to yield to the expanding root mass without the strangulation effects of synthetic fibers, which have higher tensile strengths and lack crimp.

The disclosed matrix works well for many plants, such as mustard greens, tomatoes, strawberries, and peppers, to name a few. The invention works particularly well for lettuce. Considering that 35% of the lettuce grown in the U.S. is grown hydroponically, and that number is expected to rise as the risk of food born illness and pesticide use is reduced. In addition, the development of LED lighting has been very influential in the expansion of hydroponic food production, since the cost of the power to operate LED grow lights is substantially less than for conventional high pressure sodium (HPS) lighting, until now a primary source of artificial light. This reduces hydroponic food production costs and makes hydroponics available to more crops than the high value crops that currently use hydroponics, such as cannabis and tomatoes. Also, the use of plant cultivation matrix media is adaptable to alternative growing environments, such as urban, roof-top, vertical, and backyard farming.

This invention has a positive environmental impact, since the product is produced from a renewable resource and is designed to use a grade of wool which is generally considered low quality, waste, or reprocessed wool. Waste wool in the wool growing industry is the low quality wool from the legs, belly and the skirting process, which can account for more than 25% of a fleece. Often times, this material is burned or sent to landfills, since it has little or no value for industrial use.

The environmental impact for disposal of this invention is very low, as the spent wool matrix can be left to naturally decompose as mulch, slowly forming essential plant nutrients, or it can be quickly disposed of by incineration forming ash and used as a soil amendment.

### 4. BRIEF DESCRIPTION OF THE DRAWINGS

FIG. 1 is a three-quarter perspective view of the chemically treated animal fiber matrix plant substrate of the present invention.

FIG. 2A is a side cross-section view of the chemically treated animal fiber matrix plant bats being subjected to barbed needle punching.

FIG. 2B is a close-up side cross-section view of the chemically treated animal fiber matrix plant bats being subjected to barbed needle punching.

FIG. 3 is a three-quarter exploded perspective view of the layers of the chemically treated animal fiber and synthetic fiber mesh geofabric interposed between them.

FIG. 4 is a side cross-section view of the chemically treated animal fiber matrix plant substrate of the present invention immersed in an hydroponic growth tray.

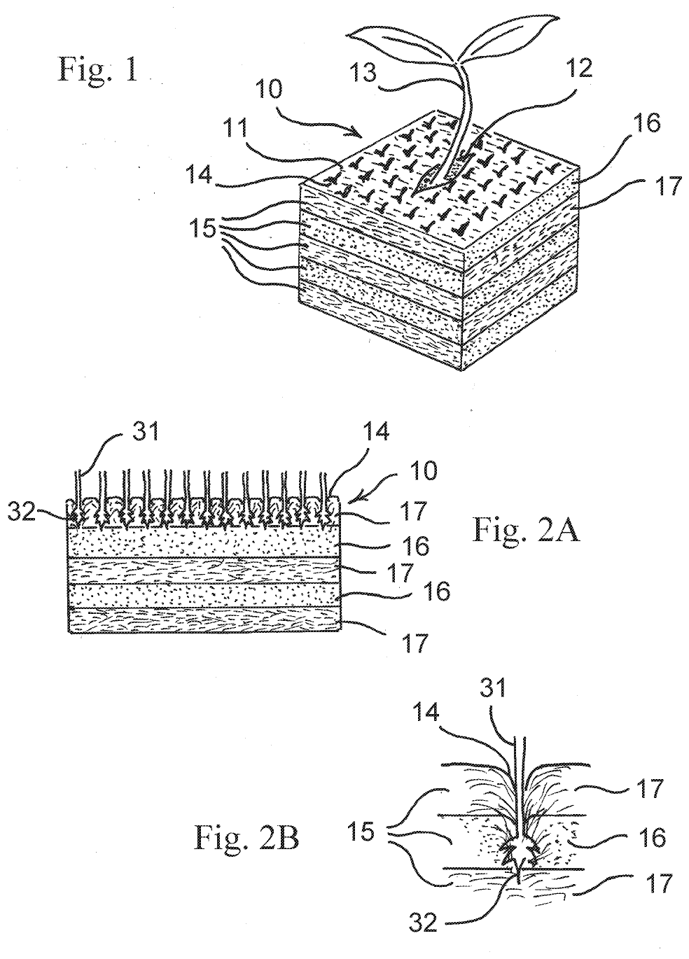

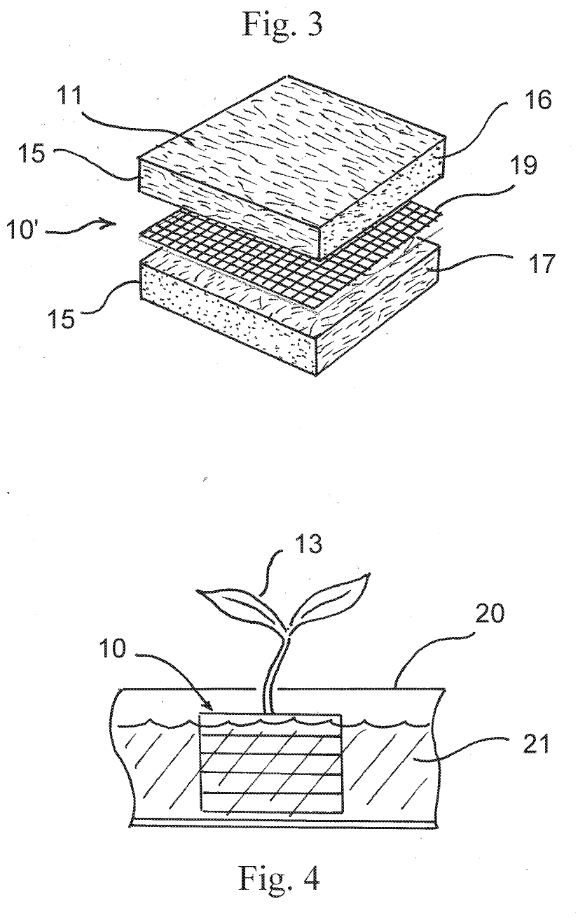

### 5. DETAILED DESCRIPTION OF THE INVENTION

The present invention features a fibrous mat matrix 10 comprised primarily of animal wool fibers in layers 15 of battings, also referred to as bats, mechanically bonded, as described below. The wool of the bat layers is chemically treated with a compound containing thiol. The chemical treatment of clean wool fiber may be performed either prior to or after the felting process. A preferred chemical is thioglycolic acid in the form of ammonium thioglycolate, which increases its solubility. The keratin molecules in the wool fibers are arranged in straight bundles held together by disulphide bonds. The disulphide bonds are made by the cysteine amino acid. The cysteine of one keratin molecule forms a disulphide bond with the cysteine of the neighboring keratin molecule Ammonium thioglycolate (HSCH₂CO₂NH₄), which contains a thiol group (—SH), breaks the disulphide bonds. The thiol group replaces one of the sulphur atoms in the disulphide bond:

Keratin-S—S-keratin+2HS—CH₂CO₂NH₄→—HO₂CH₂CS-SCH₂CO₂H+2NH₃+2HS-keratin

When the disulphide bond is broken, the keratin bundles come apart, which increases the water holding capacity of the keratin fibers. The thiol compound is allowed to work on the wool fibers.

The thiol containing compounds work best at reducing the disulfide bonds of cysteine in the cortex of wool and, as discussed below, a hydrogen peroxide treatment neutralizes the reaction and oxidizes the cysteines (HO₂CCHCH₂SH) back to cystine, but not all disulfide bonds are reformed. Numerous chemicals were tested to digest the keratin partially, as the keratin protein resists degradation. The addition of an alkaline substance, preferably calcium hydroxide (Ca(OH)₂), is used as a pH modifier to moderate or hasten the reaction of breaking the disulfide bonds. Alternative choices for a pH modifier are sodium hydroxide (NaOH), potassium hydroxide (KOH), and ammonium hydroxide (NH₄OH).

The chemical treatment may be carried out as follows:
1. For 100 grams (dry weight) of clean wool, saturate the wool with distilled water and allow to soak for 5 minutes. Remove excess water by manual squeezing until no more water flows from the wool.
2. Expose the clean, wet wool with 50 grams of an aqueous solution containing between 1% and 20% by weight of thioglycolic acid and between 0.02% to 1.5% an alkaline substance, such as ammonium hydroxide, calcium hydroxide, potassium hydroxide, or sodium hydroxide. In the preferred proportions, the clean, wet wool is exposed to an aqueous solution containing 8% by weight thioglycolic acid and 0.75% ammonium hydroxide for 45 minutes. The higher the percent of thioglycolic acid, the more rapid is the reaction of breaking disulfide bridges in the keratin. The ammonium hydroxide acts as a pH modifier by raising the alkalinity of the solution. The ammonium hydroxide, when ammonia is dissolved in water, also acts on the wool fiber, causing it to swell, which facilitates the action of the thioglycolic acid.
3. Rinse the treated wool with distilled water for 5 minutes.
4. Expose the treated wool to an aqueous solution containing up to 3.0% hydrogen peroxide for 5 minutes. Higher amounts of thioglycolic acid require more hydrogen peroxide for the neutralization step, but the amount of hydrogen peroxide should not exceed 3.0%.
5. Rinse the treated wool thoroughly for 5 minutes with distilled water. Manually squeeze and allow to dry.

If heat is applied or the percent by weight of the thioglycolic acid is increased during step 2, the chemical reaction on the wool is hastened. The pH of the thioglycolic solution also impacts the breaking of the disulfide bridges. The best results occurred in the pH range from 7.0 to 10.0.

For course wool, with an average size of about 22 microns, continuous sheets or needle-felted bats of wool can be submerged in a thiol containing aqueous environment for about 45 minutes at room temperature (approximately 70° Fahrenheit). Course wool is a good choice for the substrate, since it is most often regarded as a waste byproduct of wool production, available in large quantities, and inexpensive. The treatment time is affected by temperature. At higher temperatures, the treatment time should be reduced. For finer wool, treatment requires less time.

Alternatively, the thiol containing compound and pH modifier may be applied to the natural wool in a gaseous environment under heat, pressure, or both. In a gas treatment, some of the active ingredients may be more easily recovered for reuse.

Following treatment with the thiol containing compound, the wool is compressed to squeeze the solution from the wool and then rinsed in water.

Once the thiol compound treatment has been completed, the remaining thiol compound in the wool is neutralized with an oxidation solution containing hydrogen peroxide (H₂O₂), which reconstitutes the disulphide bonds:

2Keratin-SH+H₂O₂→Keratin-S—S-keratin+2H₂O

The treatment produces wool fibers that are slightly acidic, with a pH of approximately 5.5 to 6.0, ideal for plant growth.

The chemical treatment described above can be applied to wool that has been cleaned, prior to picking, carding, or needle punching.

Once the wool has been treated, it may be formed into a mat matrix for plant cultivation. In a preferred embodiment, the fibers are blended and carded to form bats or webs 15. The wool fibers in these bats 15 are aligned in a direction, 16 and 17, generally parallel to the mat, that is, horizontally. The bats 15 are then layered one on top of another with fiber directions, 16 or 17, transverse to each other or in an orientation between normal. The bat layers 15 are then mechanically needled (as in FIGS. 2A and 2B), whereby the bat 15 is punched and the fibers, 16 and 17, of the layers 15 are tangled by a multiplicity of barbed 32 felting needles 31. Needling can be accomplished by either a one-sided loom employing either a down stroke or an up stroke or by a double sided needle loom with or without pre-needling, commonly known as a tacker. In one preferred embodiment, several bats are needled together in multiple passes through the tacker or needle loom, producing a thicker mat of more homogeneous fiber entanglement.

In alternative embodiment, the wool fibers are formed into bats by the use of air laid fibers onto a receiving platen or belt, thereby forming a randomly arranged fiber bat, which is subsequently needled forming the final fiber entangled mat.

The cohesive mat matrix is cut into predetermined shapes, such as a cube 10 or other suitable shape. A slit 12 may be cut into the matrix substrate 10 for insertion of a seed or seedling. The slit 12 allows the roots to penetrate the substrate 10 and the plant 13 to grow outwardly.

In a preferred embodiment, the cohesive mat matrix substrate is cut into plugs 10 wherein the seedling or cutting 13 can be cultivated in the plug 10 to the point of transplant age or size and thereafter transferred to a soil or soil-less medium for continued cultivation without the damage to root tissue typically encountered in standard transplanting practice. As shown in FIG. 4, such a plug 10 is shown in a hydroponic tray 20 filled with a growth solution 21. FIG. 4 shows the plant growth substrate 10 with a plant 13 cultivated hydroponically, but may also applied to aeroponically cultivation.

The plant growth substrate 10 is formed of a cohesive matrix mat 11 of animal derived wool. The wool matrix 11 is comprised of at least 70 percent natural wool by weight. The wool fiber of the matrix 11 mat may be formed from wool from sheep, goat, alpaca, llama, or other related wool-producing species. Any remaining mixture of the wool matrix 11 may comprise organic fibers, synthetic material or a combination of organic fibers and synthetic material. The organic fibers may be, for example, cotton, jute, line, or hemp. The synthetic materials may be, for example, polyester, polyethylene, polypropylene, polyethylene terephthalate, acrylic, nylon, or olefin.

In alternative embodiment, shown in FIG. 4, a synthetic fiber mesh geofabric 19 is interposed between the layers 15 of the fiber matrix 10′ for the purpose of increasing resistance to deformation in order to adapt it for use in a green wall or green roof plant cultivation system. The reinforcing fabric layer 19, which may be natural or synthetic material, is incorporated within the natural animal wool layers 15 of a reinforced cohesive matrix 10′. When the natural animal wool layers 15 and reinforcing fabric layer 19 (or layers) are needled to entangle the wool fibers, the reinforced cohesive matrix 10′ may be used in a vertical or horizontal position, or a transition between said positions, for use as a “green roof” or “green wall” plant anchoring system.

The cohesive matrix 11 should have a density of 0:08 to 0.45 grams per cubic centimeter. The cohesive matrix 11 will comprise fibers of 7 to 50 microns in diameter and cut lengths of about 0.5 to 13 cm. A typical hydroponic plant growth substrate 10 will be in the form of a continuous mat, cut to a predetermined shape, with a thickness of from 0.2 to 30 cm. The wool and fibers of cohesive matrix 11 are randomly-arranged and entangled. Preferably, the wool and fibers of the cohesive matrix 11 are needled to form a tangled mat with a relatively vertically-aligned matrix, which promotes healthy natural root growth.

The cohesive matrix 11 mat may be formed from virgin or recycled wool, organic fibers, or synthetic material. The wool, organic fibers, or synthetic material may be dyed or pigmented.

The drawings and description set forth here represent only some embodiments of the invention. After considering these, skilled persons will understand that there are many ways to make a chemically treated animal fiber matrix plant cultivation composition according to the principles disclosed. The inventor contemplates that the use of alternative structures, materials, or manufacturing techniques, which result in a chemically treated animal fiber matrix plant cultivation composition according to the principles disclosed, will be within the scope of the invention.

1. A plant growth substrate comprising at least 70% by weight animal derived wool, wherein the animal derived wool is chemically treated with a compound containing thiol.

2. The plant growth substrate of claim 1 wherein the compound containing thiol is a thioglycolic acid.

3. The plant growth substrate of claim 2 wherein the thioglycolate acid is a salt of thioglycolic acid.

4. The plant growth substrate of claim 3 wherein the salt of thioglycolic acid is selected group consisting of ammonium thioglycolate, calcium thioglycolate, potassium thioglycolate, and sodium thioglycolate.

5. The plant growth substrate of claim 2 wherein the wool is chemically treated by submerging the wool in an aqueous solution containing the thioglycolic acid.

6. The plant growth substrate of claim 5 wherein the aqueous solution contains between 1% and 20% by weight of the thioglycolic acid and between 0.02% and 1.5% of an alkaline substance.

7. The plant growth substrate of claim 6 wherein the alkaline substance is selected from the group consisting of calcium hydroxide, sodium hydroxide, potassium hydroxide, or ammonium hydroxide.

8. The plant growth substrate of claim 7 wherein the aqueous solution contains 8% by weight of thioglycolic acid and 0.75% by weight of the alkaline substance.

9. The plant growth substrate of claim 2 wherein the wool is chemically treated by enclosing the wool in a gaseous environment containing the thioglycolic acid.

10. The plant growth substrate of claim 9 wherein the wool is enclosed in the gaseous environment under pressure above atmosphere.

11. The plant growth substrate of claim 1 wherein the animal derived wool is from sheep, goat, alpaca or llama.

12. The plant growth substrate of claim 1 wherein the animal derived wool is formed into a felt bat.

13. The plant growth substrate of claim 12 wherein the felt bat is formed into at least two felt bat layers and the at least two felt bat layers are layered one atop another.

14. The plant growth substrate of claim 13 wherein the at least two felt bat layers are needle punched to entangle the wool fibers between the at least two felt bat layers.

15. The plant growth substrate of claim 14 wherein the substrate has a horizontal orientation and the wool fibers entangled between the at least two felt bat layers form wool fibers oriented in a vertical direction with respect to the horizontal orientation of the substrate.

16. The plant growth substrate of claim 15 wherein the at least two felt bat layers form a height between 0.5 cm and 30 cm.

17. The plant growth substrate of claim 1 wherein a plant is cultivated within the substrate hydroponically.

18. The plant growth substrate of claim 1 wherein a plant is cultivated within the substrate aeroponically.

19. The plant growth substrate of claim 14 further comprising a reinforcing fabric between the at least two felt bat layers to adapt the plant growth substrate.
